(19) United States
(12) Patent Application Publication
(10) Pub. No.: US 2016/0162210 A1
(43) Pub. Date: Jun. 9, 2016

(54) OPENSTACK SWIFT INTERFACE FOR TAPE LIBRARY (OSSITL)

(71) Applicant: BDT Media Automation GmbH, Rottweil (DE)

(72) Inventors: Franz Bucher, Villingen-Schwenningen (DE); Andreas Kleber, Dauchingen (DE)

(21) Appl. No.: 14/564,255

(22) Filed: Dec. 9, 2014

(51) Int. Cl. G06F 3/06

(52) U.S. Cl. CPC G06F 3/0619; G06F 3/0686; G06F 3/065; G06F 3/0644

(57) ABSTRACT

A system for providing a Swift Storage Node includes a media library having drives and tapes formatted according to a Linear Tape File System (LTFS). A management system is connected over a first interface to the media library and over a second interface to a Swift Proxy Server. The management system provides a Swift-On-Disk File System Application Programming Interface (API) over the second external interface, uses a Virtual File System (VFS), stores and registers objects in the VFS, controls the media library to move a respective tape into a respective drive, moves the object from the cache data store to the respective tape using the LTFS and updates the VFS. The management system also receives a request over the Swift-On-Disk File System API to read an object, determines in the VFS the location of the object, loads the object using the LTFS and provides the object.

### FIELD

The invention is related to a concept for a seamless integration of a Tape Library into an OpenStack Swift Storage infrastructure. The tape library should act as a standard storage node in a Swift Object Storage cluster without modifications of the generic structure and software components of Swift. Swift supports a basic plugin concept “Pluggable On-Disk Back-end API” to integrate individual data storage implementations for different storage device types.

It is intended to provide a way to integrate a tape library with its legacy SCSI/SAS interfaces, which are not supported directly anymore, in the new Cloud based infrastructures.

### BACKGROUND

Businesses, governmental organizations and other entities are increasingly saving large volumes of data necessary for daily operations. The data represents a significant asset for these entities. Consequently, data loss, whether accidental or caused by malicious activity, can be costly in terms of wasted manpower, loss of goodwill from customers, loss of time and potential legal liability. To ensure proper protection of data for business and legal purposes (e.g., to ensure quick recovery of data in the event of a disaster, to comply with document retention requirements, etc.), these entities often back up data to a physical media, such as magnetic tapes or optical disks on a regular basis.

Traditional backup systems placed an application server, backup server, source device, destination device and a local area network (“LAN”) in the data path of backup operations. Under these systems, the LANs were becoming overburdened by the amount of data being copied. Often, the backup window (the period in which data unavailable for normal operations in order to permit backup) was too short to achieve a complete backup of data. Accordingly, many entities implemented Storage Area Networks (“SAN”) to relieve the burden of mass data storage and backup from the LAN, freeing the LAN for more immediate data storage and manipulation operations. In SANs, data from multiple machines on a network may be backed up to a remote media library. Centralized data backup allows storage problems to be identified at one location and has the advantage of increased efficiency.

One example of a media library commonly used in enterprise backup systems is a magnetic tape library. In a typical magnetic tape library, tapes are contained in cartridges and the tape library contains multiple cartridge slots in which tape cartridges can be stored. The tape cartridges are physically moved between cartridge slots and tape drives by a robot. The robot is controlled by access commands received from the host devices on the network. When specific data is required, the host device determines which cartridge slot contains the tape cartridge that holds the desired data. The host device then transmits a move-element command to the robot and the robot moves the tape cartridge.

In a SCSI/SAS tape library, for example, devices that are part of the library are typically addressed by target number and logical unit numbers (“LUN”). Thus, each drive and robot of a tape library typically has a target number and LUN. Cartridge slots, on the other hand, are addressed by element numbers that are used by the robot to locate the slots. Because the robot also places tape cartridges in the drives, each drive is also associated with an element number. If multiple tape libraries are connected to a single device (e.g., a fibre channel to SCSI router, etc.), the tape libraries may be further addressed by bus number.

In current tape library systems, each tape library may present itself as an independent entity on the network. Each host in these systems maintains a view (i.e., a table of target numbers, LUNs and element numbers) of each of the tape libraries. Using this address information a host can format commands to the tape library to perform read/write, backup and other operations. In order to coordinate activities, hosts must cooperate with each other in issuing these commands.

Enabling cooperation, however, requires some form of application to arbitrate between the various hosts or applications that are accessing the tape library. Thus, it may be necessary to employ some form of application (such as a backup application, like Microsoft Software Initiator, Backup Exec/Symantec etc.) to read and write tapes in a tape library. Additionally, many of these issues may only be dealt with in software if the hosts use the same application or at least compatible applications. For example, if two hosts use the same backup application to store their data to tape, the application can coordinate the access requests of the two hosts so that both are backed up to the tape library. If, on the other hand, the two hosts use different backup applications, the applications will most likely not be able to coordinate their actions to ensure that both of the hosts are properly backed up, since they were probably independently designed and are consequently incompatible. Thus, to prevent conflicts between hosts, each host must typically use the same application to access a shared tape library. This can be inefficient as individual tape libraries cannot store data from multiple applications. Moreover, the files written on a tape by a backup application are written in a format proprietary to that backup application. Thus, to restore or otherwise access files on those tapes, the same backup application is required.

Recently, however, the Ultrium Linear Tape Open (LTO)-5 and later, specification for tapes (hereby incorporated by reference in its entirety for all purposes) has included support for partitioning. The Linear or Long Term File System (LTFS) Format Specification by IBM and Ultrium (also hereby fully incorporated by reference in its entirety for all purposes) makes use of this partitioning support to define a tape format. The LTFS tape format defines a file system for LTO-5 tapes using an eXtensible Markup Language (XML) schema architecture and was utilized in conjunction with the IBM LTO Gen5 and higher Drive. This file system support allows the use of an LTFS-formatted tape as if it were a file system. Files and directories may appear in a directory listing, files may be dragged and dropped from tape, data may be accessed at the file level, etc. With LTFS, tape media can be used like other storage media (e.g. flash drive, hard disk drives, etc.).

Consequently, while it previously was necessary to make use of a backup application to write and read tapes, the introduction of LTFS has simplified the storing and retrieval of files on tape by reducing such operations to a copy. Furthermore, any operating system that includes LTFS support can mount an LTFS formatted tape and read and write the files thereon.

Although LTFS makes the use of a single tape much simpler, it does, however, have limitations. As defined in the current specification the LTFS file system may be limited to a single tape. If it is desired to use multiple LTFS tapes these tapes are mounted one at a time or additional support is provided. While the capacity of an LTO-5 tape is relatively high (e.g., around 1500 GB to 3.0 TB or greater) in the realm of business data and backup applications this is a major restriction.

Another significant limitation of the LTFS specification is that it does not include support for tape libraries. The LTFS specification only defines a single tape/tape drive combination. After the tape drive is loaded with the tape the file system may be mounted after which it becomes useable. Manual intervention is required to unload one tape and load another if access to files on a different tape is desired.

It is thus desired to effectively leverage tape libraries to provide storage in conjunction with a networked based file system and, particularly, to provide a networked based file system utilizing tape libraries that employ LTFS.

U.S. Pat. No. 8,527,561 discloses the approach to implement a NAS (network attached storage) based on CIFS or NFS Protocol etc. with a tape library. These protocols allow a concurrent access of multiple devices over Ethernet to the device.

OpenStack (<<www.openstack.org>>) is a cloud operating system that controls large pools of compute, storage, and networking resources throughout a datacentre, all managed through a dashboard that gives administrators control while empowering their users to provision resources through a web interface.

OpenStack is an open source infrastructure as a service (IaaS) initiative for creating and managing large groups of virtual private servers in a cloud computing environment.

The goals of the OpenStack initiative are to support interoperability between cloud services and allow businesses to build Amazon-like cloud services in their own data centres. OpenStack, which is freely available under the Apache 2.0 license, is often referred to in the media as “the Linux of the Cloud” and is compared to Eucalyptus and the Apache CloudStack project, two other open source cloud initiatives.

OpenStack officially became an independent non-profit organization in September 2012. The content of the OpenStack definitions and documents at (<<www.openstack.org>>) are hereby incorporated by reference herein.

In the following the components of OpenStack are explained.

### Nova:

Nova is the primary computing engine behind OpenStack. It is a “fabric controller,” which is used for deploying and managing large numbers of virtual machines and other instances to handle computing tasks.

### Cinder:

Cinder is a block storage component, which is more analogous to the traditional notion of a computer being able to access specific locations on a disk drive. This more traditional way of accessing files might be important in scenarios in which data access speed is the most important consideration.

### Swift:

Swift is a storage system for objects and files. Rather than the traditional idea of a referring to files by their location on a disk drive, developers can instead refer to a unique identifier referring to the file or piece of information and let OpenStack decide where to store this information. This makes scaling easy, as developers don't have the worry about the capacity on a single system behind the software. It also allows the system, rather than the developer, to worry about how best to make sure that data is backed up in case of the failure of a machine or network connection.

In the following the Swift components and concepts will be discussed.

### Swift Storage Concept:

Swift offers cloud storage software where you can store and retrieve lots of data with a simple API. It's built for scale and optimized for durability, availability, and concurrency across the entire data set. Swift is ideal for storing unstructured data that can grow without bound. Swift has an extremely scalable architecture, based on standard commodity HW and basic storage systems.

### Swift Components:

The following sub chapters are copied from the OpenStack Developer Documentation to explain the general Swift concept.

### Swift—Proxy Server:

The Proxy Server is responsible for tying together the rest of the Swift architecture. For each request, it will look up the location of the account, container, or object in the ring (see below) and route the request accordingly. The public API is also exposed through the Proxy Server.

A large number of failures are also handled in the Proxy Server. For example, if a server is unavailable for an object PUT, it will ask the ring for a handoff server and route there instead.

When objects are streamed to or from an object server, they are streamed directly through the proxy server to or from the user—the proxy server does not spool them.

### Swift—The Ring:

A ring represents a mapping between the names of entities stored on disk and their physical location. There are separate rings for accounts, containers, and objects. When other components need to perform any operation on an object, container, or account, they need to interact with the appropriate ring to determine its location in the cluster.

The Ring maintains this mapping using zones, devices, partitions, and replicas. Each partition in the ring is replicated, by default, 3 times across the cluster, and the locations for a partition are stored in the mapping maintained by the ring. The ring is also responsible for determining which devices are used for handoff in failure scenarios.

Data can be isolated with the concept of zones in the ring. Each replica of a partition is guaranteed to reside in a different zone. A zone could represent a drive, a server, a cabinet, a switch, or even a datacenter.

The partitions of the ring are equally divided among all the devices in the Swift installation.

When partitions need to be moved around (for example if a device is added to the cluster), the ring ensures that a minimum number of partitions are moved at a time, and only one replica of a partition is moved at a time.

Weights can be used to balance the distribution of partitions on drives across the cluster. This can be useful, for example, when different sized drives are used in a cluster.

The ring is used by the Proxy server and several background processes (like replication).

### Swift—Object Server:

The Object Server is a very simple blob storage server that can store, retrieve and delete objects stored on local devices. Objects are stored as binary files on the filesystem with metadata stored in the file's extended attributes (xattrs). This requires that the underlying filesystem choice for object servers support xattrs on files. Some filesystems, like ext3, have xattrs turned off by default. Each object is stored using a path derived from the object name's hash and the operation's timestamp. Last write always wins, and ensures that the latest object version will be served. A deletion is also treated as a version of the file (a 0 byte file ending with “.ts”, which stands for tombstone). This ensures that deleted files are replicated correctly and older versions don't magically reappear due to failure scenarios.

### Swift—Container Server:

The Container Server's primary job is to handle listings of objects. It doesn't know where those object's are, just what objects are in a specific container. The listings are stored as sqlite database files, and replicated across the cluster similar to how objects are. Statistics are also tracked that include the total number of objects, and total storage usage for that container.

### Swift—Account Server:

The Account Server is very similar to the Container Server, excepting that it is responsible for listings of containers rather than objects.

### Swift—Replication:

Replication is designed to keep the system in a consistent state in the face of temporary error conditions like network outages or drive failures.

The replication processes compare local data with each remote copy to ensure they all contain the latest version. Object replication uses a hash list to quickly compare subsections of each partition, and container and account replication use a combination of hashes and shared high water marks. Replication updates are push based. For object replication, updating is just a matter of rsyncing files to the peer. Account and container replication push missing records over HTTP or rsync whole database files. The replicator also ensures that data is removed from the system. When an item (object, container, or account) is deleted, a tombstone is set as the latest version of the item. The replicator will see the tombstone and ensure that the item is removed from the entire system.

### Swift—Updaters:

There are times when container or account data cannot be immediately updated. This usually occurs during failure scenarios or periods of high load. If an update fails, the update is queued locally on the filesystem, and the updater will process the failed updates. This is where an eventual consistency window will most likely come in to play. For example, suppose a container server is under load and a new object is put in to the system. The object will be immediately available for reads as soon as the proxy server responds to the client with success. However, the container server did not update the object listing, and so the update would be queued for a later update. Container listings, therefore, may not immediately contain the object. In practice, the consistency window is only as large as the frequency at which the updater runs and may not even be noticed as the proxy server will route listing requests to the first container server which responds. The server under load may not be the one that serves subsequent listing requests—one of the other two replicas may handle the listing.

### Swift—Auditors:

Auditors crawl the local server checking the integrity of the objects, containers, and accounts. If corruption is found {in the case of bit rot, for example), the file is quarantined, and replication will replace the bad file from another replica. If other errors are found they are logged (for example, an object's listing can't be found on any container server it should be).

### SUMMARY

In an embodiment, the present invention provides a system for providing a Swift Storage Node. A media library has one or more drives and one or more tapes formatted according to a Linear Tape File System (LTFS). A management system is connected over a first interface to the media library and over a second interface to a Swift Proxy Server. The management system has a processor, a cache data store and a set of computer instructions executable on the processor to: provide a Swift-On-Disk File System Application Programming Interface (API) over the second external interface; use a Virtual File System (VFS) base on the cache data store and the tapes formatted according to the LTFS to be mapped to a Swift-On-Disk File standard; receive a request over the Swift-On-Disk File System API to store an object according to the Swift-On-Disk standard, store and register the object in the VFS, wherein the object is stored in a first step on the cache data store, control the media library to move a respective tape into a respective drive, mount the respective tape using the LTFS in the respective drive according to the VFS and move the object from the cache data store to the respective tape using the LTFS and update the VFS; and receive a request over the Swift-On-Disk File System API to read an object, determine in the VFS the location of the object, provide the object from the cache data store based on a determination that the object is still in the cache data store, control the media library to move a respective tape into a respective drive, mount the respective tape using the LTFS in the respective drive according to the VFS, load the object using the LTFS and provide the object.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a OpenStack structure with Block Storage and Object Storage;

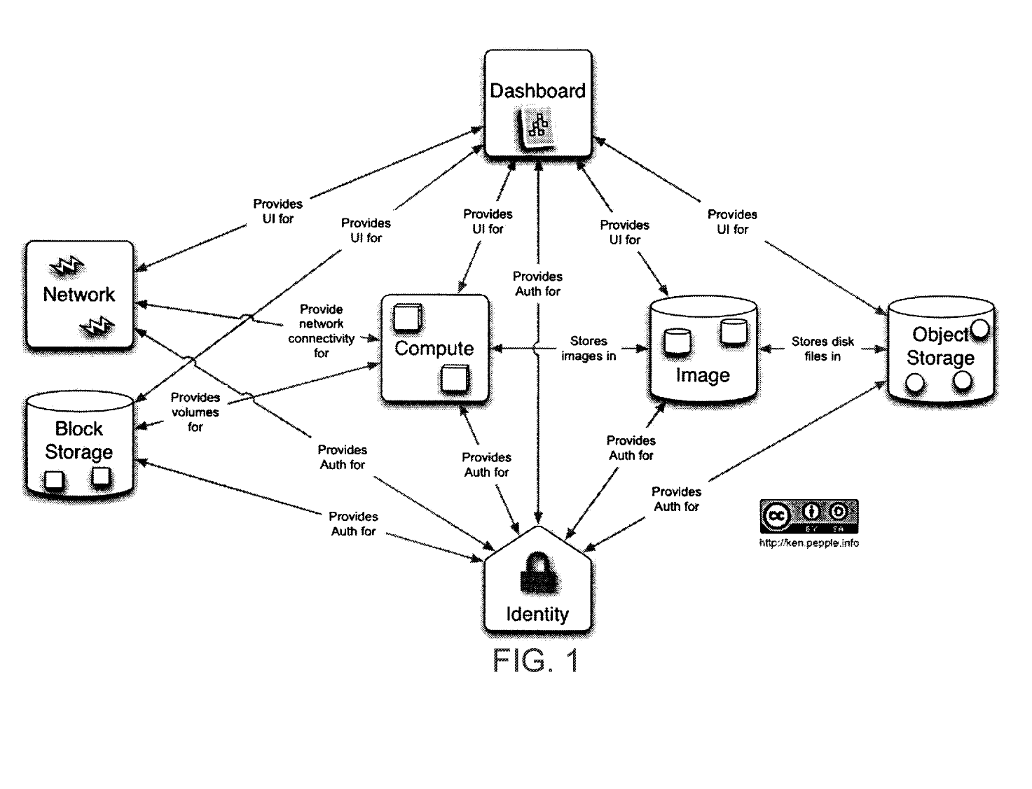

FIG. 2 shows the swift hardware architecture;

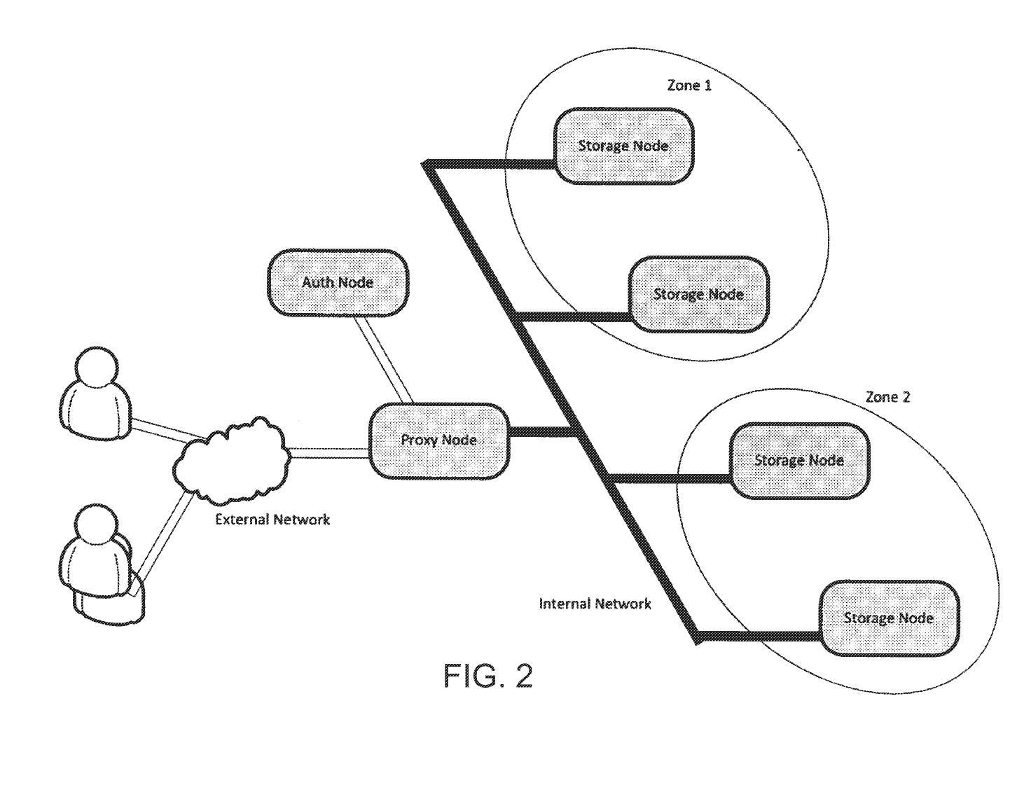

FIG. 3 shows the integration of a Tape-Storage-Node into the Storage Nodes;

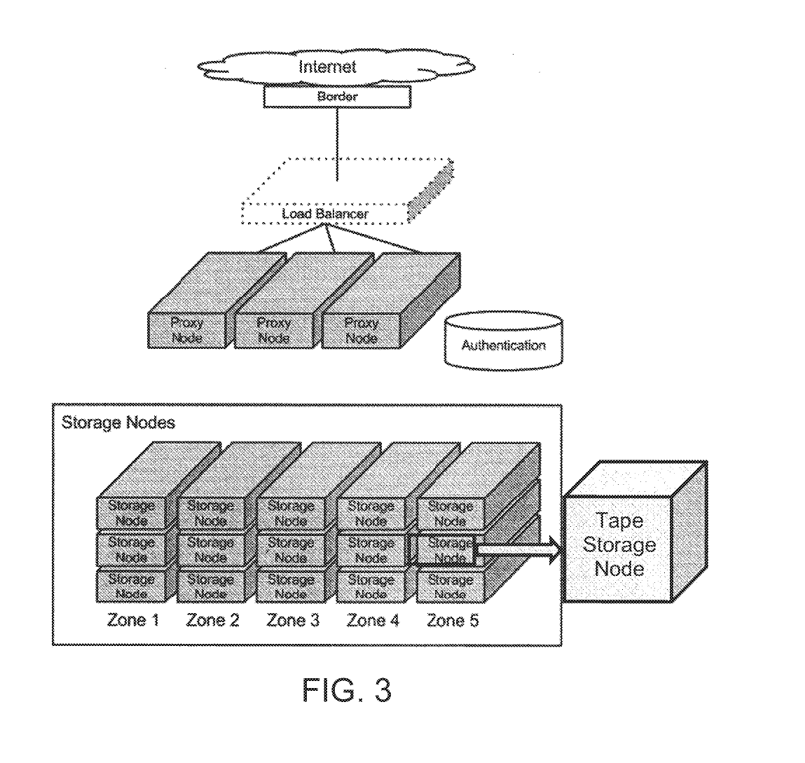

FIG. 4 shows a standard storage node architecture;

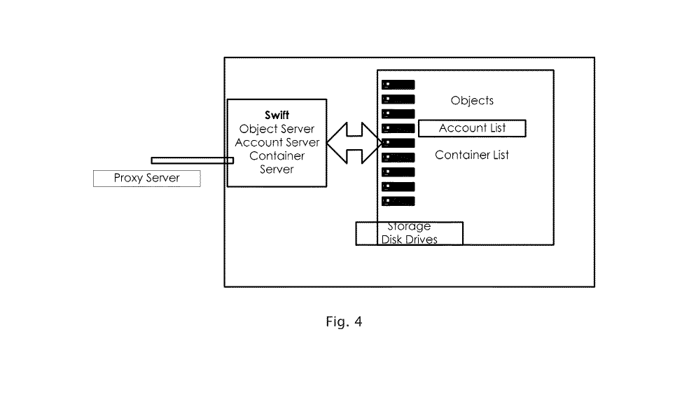

FIG. 5 shows a native swift storage node structure;

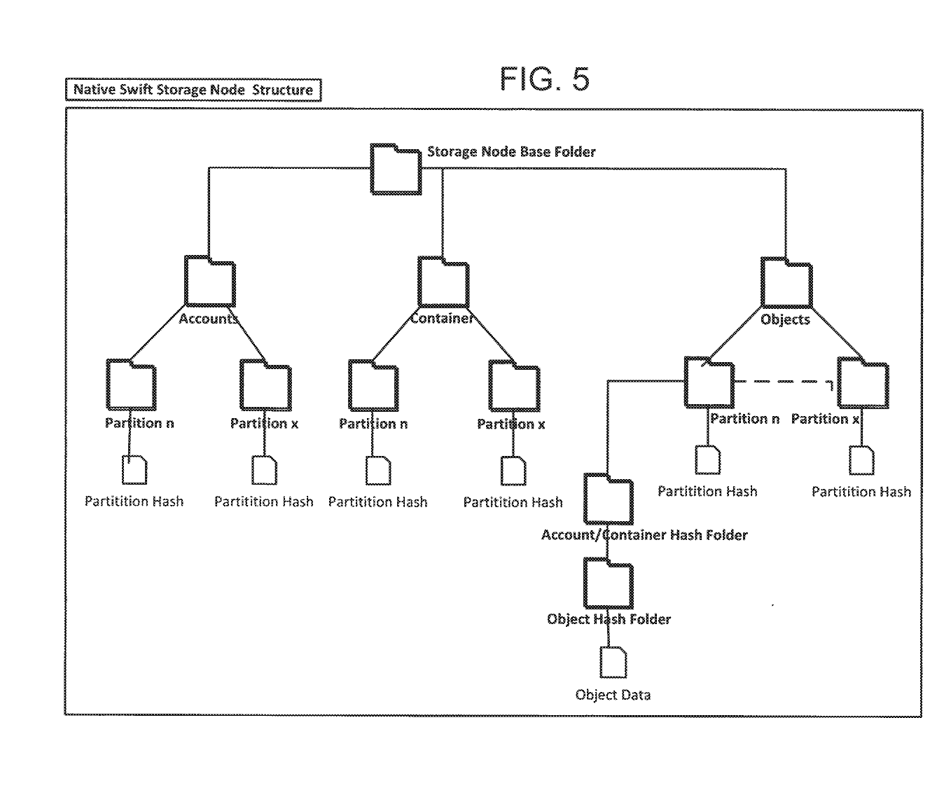

FIG. 6 shows the integration of a tape library into a Swift Storage Node;

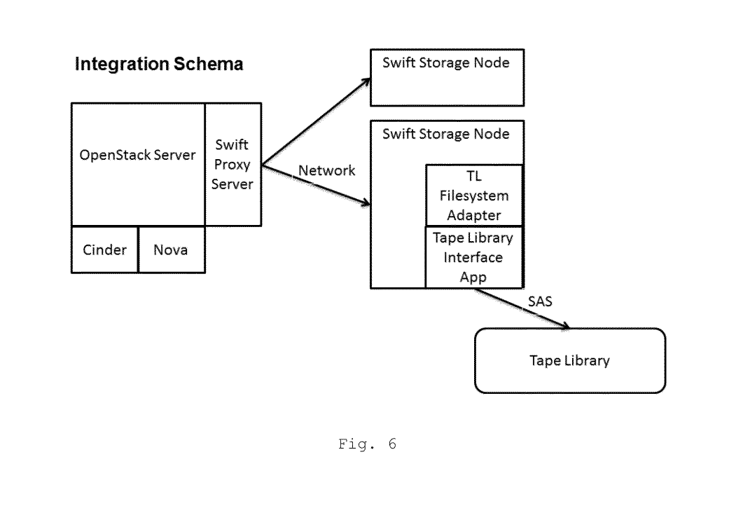

FIG. 7 shows the internal structure of the storage node using the tape library;

FIG. 8 shows the internal structure using a standard operating system like linux;

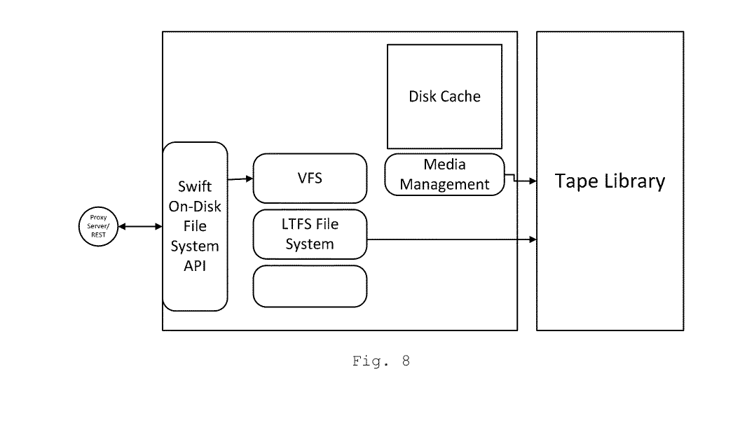

FIG. 9 shows a storage node structure using links for objects on tape;

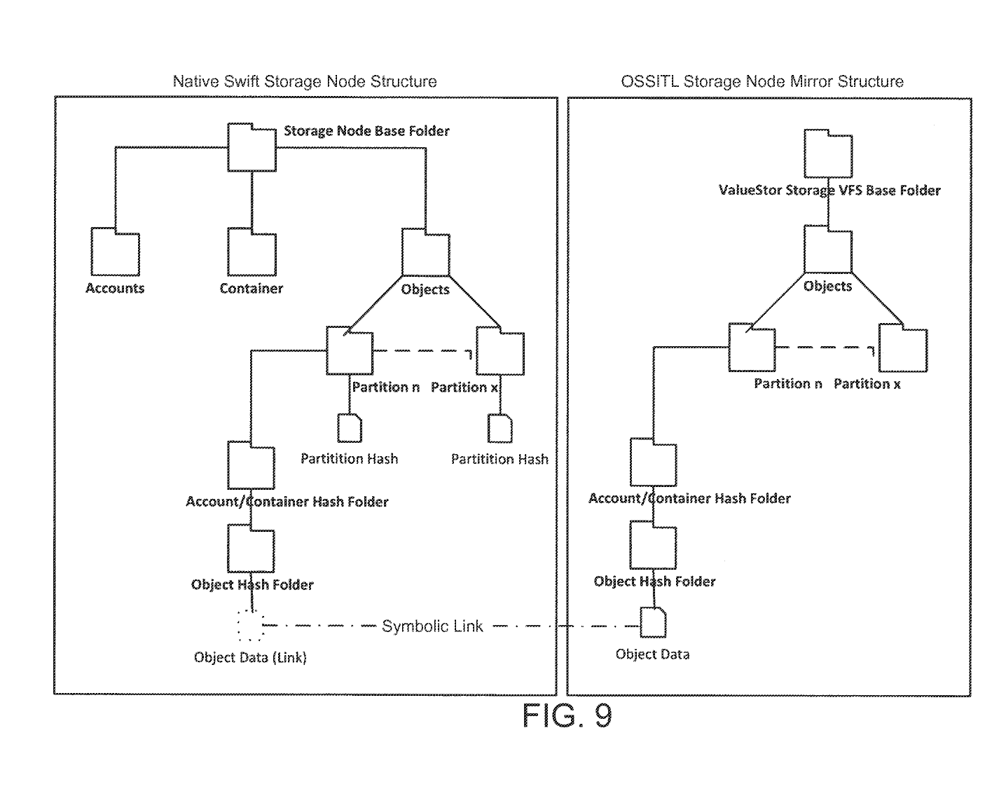

FIG. 10 shows a storage node structure where complete storage node file tree we be stored on tape.

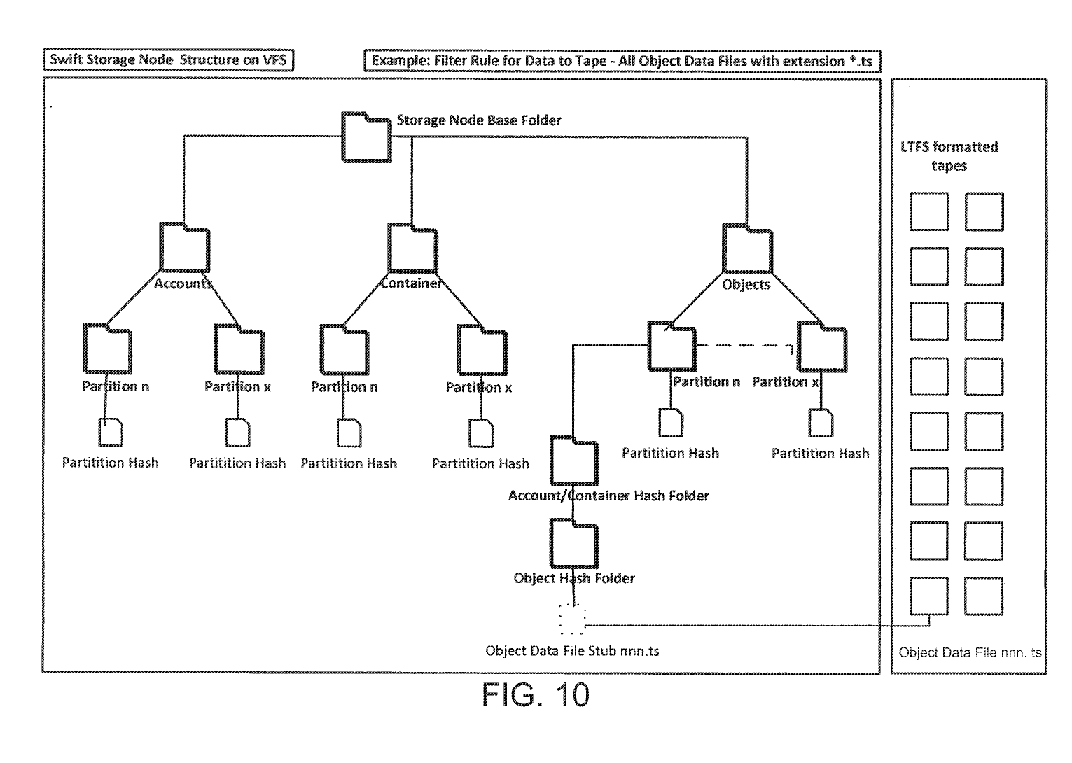

### DETAILED DESCRIPTION

In an embodiment, the present invention provides a system for providing a Swift Storage Node, the system comprising:

a) a media library, comprising:
one or more drives;
one or more tapes formatted according to the Linear Tape File System (LTFS); and
   b) a management system connected over a first interface to the media library and over a second interface to a Swift Proxy Server, comprising a processor, a cache data store and a set of computer instructions executable on the processor to:
provide a Swift-On-Disk File System Application Programming Interface (API) over the second external interface;
use Virtual File System (VFS) base on the cache data store and the tapes with LTFS to be mapped to the Swift-On-Disk File standard;
receive a request over Swift-On-Disk File API to store an object according to the Swift-On-Disk standard, storing and registering the object in the VFS, comprising storing the object in a first step on the cache data store, controlling the library to move a tape into one of the drives, mounting a tape using LTFS in the drive according to the VFS, moving the object from the cache data store to the tape using LTFS and updating the VFS;
receive a request over Swift-On-Disk File API to read an object, determining in the VFS the location of the object, if the object is still stored in the cache data store, providing the object from the cache data store, otherwise controlling the library to move a tape into one of the drives, mounting the tape using LTFS in the drive according to the VFS, loading the object using LTFS and providing the object.

In another embodiment, the VFS is configured to unify several LTFS on tapes and the cache data store as a one large unified storage area to provide this unified storage area to the Swift-On-Disk File standard. For an external user only one complete storage area is offered being the sum of all tapes available for the VFS. In general the cache data store is only redundant and improves the access time to the objects stored or the additional data.

In a possible implementation, an adapted virtual file system (VFS) keeps the SWIFT structure and a metadatabase. Further this adapted virtual file system (VFS) allows marking elements of the folder structure by help of a variable and definable set of rules. Once marked, elements of the folder structure can be stored either to tape or disk. Logically all elements stay in the standard SWIFT folder structure in the VFS, but physically elements which have been marked for tape storage by help of rules, will be stored on tape. The actual storage location of the respective elements is reflected in the metadatabase.

The rules can e.g. be triggered by time, file sizes, file types, frequency of access etc.

In a possible embodiment, tapes copies are generated in the background for redundant data storage. Based on this approach data loss can be minimized and also copies of the tapes can be exported out of the library, to take them away for safety reasons.

The cache management can use technologies well known in the field, wherein the objects in the cache data store being removed if a copy of the object is on the tapes and a cache-rule determines the object to be removed.

In a possible embodiment, the library is partitioned by aggregating a number of drives and a number of tapes smaller than the total number of drives and the total number tapes to a partition, and each partition providing a separate Swift-On-Disk File System Application Programming Interface (API) over the second external interface. This allows to provide with a single devices multiple API.

In a possible embodiment, the device provides a user interface to determine one or more of the following parameters: partitioning, cache size, cache-rules, tapes to be copied, export of tapes.

In a possible embodiment, the first interface is one of the following: scsi, fc, iscsi, sas, and wherein the second interface is one of the following: RESTful interface, SWIFT Storage Node interface including account, container and object services.

By this implementation Tape library interface looks like as a standard generic (disk-based) Storage Node interface (tape library is transparent to Object Store software). There is no modification on the Object Store software (e.g. SWIFT) necessary, all common features of an Object Storage (incl. Auditing, Replication, Recovery) are still supported. The virtual SWIFT Standard Storage Node is being supported by an adapted virtual file system (VFS) allowing rule based data storage to tape by using LTFS data format to write/read files directly to tape.

SWIFT consists of a RESTful interface for Object Store Storage node supporting RESTful API http methods (GET, PUT, POST, DELETE) to read/write data from/to tapes in a tape media library.

The Virtual File System implementation is used to combine the local LTFS based files systems of several tapes to one joined root file system (e.g. to combine 5 LTO6 tapes to a file system with an overall capacity of 5×2.5 TB=12.5 TB) allowing reading and writing files directly to tape.

The Virtual File System implementation includes a metadatabase, which e.g. could be file based and stores all mappings of the files on the affected tapes (Object Store Software won't know on which tape a file was written, just the VFS Software will know).

The Virtual File System implementation includes a write cache to queue files until the target tape becomes available for writing (load the right tape into an available tape drive)

The Virtual File System implementation includes a read cache to ensure fast read access.

A Tape Library management controller software/hardware which controls the tape library (e.g. load/unload tapes to the tape drives) is also implemented. The Library management controller keeps track on the drives used and the tapes in the slots. It provides status information about the tapes in the drives, and the barcodes of the tapes. It is used to transport the tapes into the drives and from the drives. Also the Library management controller is used to export tapes to a mail slot which allows removing the tape from the library. Also an unlocking of the magazines is handled by the controller.

The invention and the various features and advantageous details thereof are explained more fully with reference to the nonlimiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure. Embodiments discussed herein can be implemented in suitable computer-executable instructions that may reside on a computer readable medium (e.g., a hard disk drive, flash drive or other memory), hardware circuitry or the like, or any combination. Before discussing specific embodiments, embodiments of a hardware architecture for implementing certain embodiments is described herein. One embodiment can include one or more computers communicatively coupled to a network, especially a fibre channel (FC), serial attached scsi (SAS), scsi (small computer system interface), iscsi (internet scsi). As is known to those skilled in the art, the computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (such as a mouse, trackball, stylist, etc.) or the like. In various embodiments, the computer has access to at least one database.

ROM, RAM, and HD are computer memories for storing computer-executable instructions executable by the CPU. Within this disclosure, the term “computer-readable medium” is not limited to ROM, RAM, and HD and can include any type of data storage medium that can be read by a processor. In some embodiments, a computer-readable medium may refer to a data cartridge, a data backup magnetic tape, a floppy diskette, a flash memory drive, an optical data storage drive, a CD-ROM, ROM, RAM, HD, or the like.

At least portions of the functionalities or processes described herein can be implemented in suitable computer-executable instructions. The computer-executable instructions may be stored as software code components or modules on one or more computer readable media (such as non-volatile memories, volatile memories, DASD arrays, magnetic tapes, floppy diskettes, hard drives, optical storage devices, etc. or any other appropriate computer-readable medium or storage device). In one embodiment, the computer-executable instructions may include lines of complied C++, Java, HTML, or any other programming or scripting code.

Additionally, the functions of the disclosed embodiments may be implemented on one computer or shared/distributed among two or more computers in or across a network.

Communications between computers implementing embodiments can be accomplished using any electronic, optical, radio frequency signals, or other suitable methods and tools of communication in compliance with known network protocols.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited only those elements but may include other elements not expressly listed or inherent to such process, article, or apparatus.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations include, but is not limited to: “for example,” “for instance,” “e.g.,” “in one embodiment.”

It will be recalled from the above discussion that in many instances it may be desired to provide a file system utilizing media libraries. To that end, attention is now directed to systems and methods for implementing a file system utilizing a tape library. In particular, embodiments may present a network based file system to one or more host devices. These host devices may utilize the network based file system to organize, store, read or perform other operations in association with files. These files may be managed in conjunction with a tape library. Specifically, commands in a network file system protocol may be received. These commands may be associated with operations to be performed on files, including operations associated with the organization, storage or retrieval of those files. Library control functionality that allows tapes in the tape library to be tracked and tapes to be moved into and out of drives and storage slots is utilized to manage the tape library such that those commands can be implemented in conjunction with the tape library.

In certain embodiments, LTFS may be employed in conjunction with the tape library such that the tapes in the tape library may be formatted using LTFS. Accordingly, operations with respect to the files on the tapes in the tape library may be performed using LTFS. A mapping may be maintained between the files visible through the networked based file system presented to the host devices and the corresponding location of those files on an LTFS tape in the tape library. Thus, when a command for an operation on a file is received from a host, the proper tape in the tape library can be located, placed in a drive and the LTFS file system on the tape mounted. The operation on the file can then be performed using LTFS. It should be noted here that while embodiments as discussed include a tape library having tapes formatted according to LTFS, other types of media libraries that utilize media of the same or different type where the media may be formatted according to the same or another type of file system may be employed in other embodiments.

Based on the fact that Swift Object Storage still is based on a random accessible file system to store it's object data and tapes still are sequential media there is a need for a translating interface between both worlds.

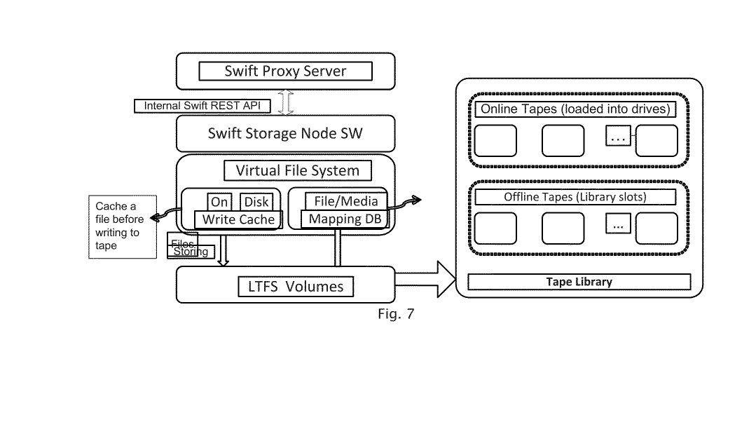

As shown in FIG. 7 the design of the invention has a number of the requirements for such a tape based storage device:
Based on standard Linux Server OS
Storing files on tape media
Presenting a random file system to the connecting systems
Transparent management of tape library operations
Virtualization of single media
Clustering multiple media to single media
Use of proven tape file system LTFS to store and manage file based data on tape

An embodiment is preferably based on the LTFS file system, which presents a tape volume as a normal file system folder where all standard file operations are supported against the OS and the user. To expose this file system with some major enhancements regarding usability and functional stability is one goal of the invention.

A component of the invention is its virtual file system (VFS) which controls the file and the cache management. Caching of data is a very important feature to fulfill the requirement for fast file access and to overcome the inherent delays of tape with long lead time for loading a tape and seeking sequentially on it. The VFS moves the files from the cache to the tape as quickly as possible based on set of rules to ensure high efficiency or restores the files from tape based on a read request if the files are moved out to the tape storage tier.

An embodiment of the invention is designed to run on a standard server HW running a standard Linux Server OS like SLES or RHEL other operating system can also be used. Depending on performance and storage requirements it will be configured with multiple TB of disk cache.

In a preferred embodiment, the minimum size of the cache is larger than the expected maximum size of the largest object to be stored.

The system concept can also be used in an alternative possible embodiment a to provide both a network filesystem like NFS or CIFS as the backend and a “Pluggable On-Disk Back-end API” as the front end part for this new type of storage node.

There can be different variants and concepts to integrate the invention as the backend to tape library storage. This would also minimize the failure risk and test effort.

In a preferred embodiment of the invention, the standard implementation of the Swift Backend File System will still stay on the virtual file system (VFS). The complete folder and file structure will be kept without change. The only difference will be that the element data which has been marked by help of definable rules will be stored on tape. The metadatabase running on the virtual file system links to this data. Like that the original Swift structure will be kept unchanged to an external observer. In this case the file system structure looks logically the same as the standard, only the metadatabase link will be the difference.

The advantages would be:
The default structure and behavior will not change.
No generic modifications in the existing Swift “File System Back-End API” code is necessary.
Individually definable rules allow setting up the system to its needs, not necessary slow tape operations can be avoided.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A system for providing a Swift Storage Node, comprising:
a media library, comprising:
one or more drives; and
one or more tapes formatted according to a Linear Tape File System (LTFS); and
a management system connected over a first interface to the media library and over a second interface to a Swift Proxy Server, comprising a processor, a cache data store and a set of computer instructions executable on the processor to:
provide a Swift-On-Disk File System Application Programming Interface (API) over the second external interface;
use a Virtual File System (VFS) base on the cache data store and the tapes formatted according to the LTFS to be mapped to a Swift-On-Disk File standard;
receive a request over the Swift-On-Disk File System API to store an object according to the Swift-On-Disk standard, store and register the object in the VFS, wherein the object is stored in a first step on the cache data store, control the media library to move a respective tape into a respective drive, mount the respective tape using the LTFS in the respective drive according to the VFS and move the object from the cache data store to the respective tape using the LTFS and update the VFS; and
receive a request over the Swift-On-Disk File System API to read an object, determine in the VFS the location of the object, and:
provide the object from the cache data store based on a determination that the object is still in the cache data store, else
control the media library to move a respective tape into a respective drive, mount the respective tape using the LTFS in the respective drive according to the VFS, load the object using the LTFS and provide the object.

2. The system according to claim 1, wherein the VFS is configured to unify several LTFS on the tapes and the cache data store as one large unified storage area to provide the unified storage area to the Swift-On-Disk File standard.

3. The system according to claim 1, wherein a SWIFT Standard Storage Node structure is kept for tape based storage by help of an adapted virtual file system including a metadatabase.

4. The system according to claim 1, wherein a complete storage node file tree and the object is stored in the VFS.

5. The system according to claim 4, further comprising a separate cache area defined on the cache data store which is large enough to store a copy of all folder/file structure on the tapes, the separate cache area being copied to the tapes regularly on a base of rules.

6. The system according to claim 1, wherein the VFS consists of a VFS-metadatabase storing object identifications together with a location of the object on the tapes or the cache data store.

7. The system according to claim 1, wherein a table of the VFS comprises several location entries for one object identification together with a date of change based on the object being stored on multiple ones of the tapes or on the cache data store and one of the tapes.

8. The system according to claim 1, wherein the system is configured to generate tape copies in the background for redundant data storage.

9. The system according to claim 9, wherein the system is configured to export the tape copies out of the library.

10. The system according to claim 1, wherein the system is configured to remove objects in the cache data store based on a copy of a respective object being on the tapes, wherein a cache-rule determines the respective object to be removed.

11. The system according to claim 1, wherein the media library is partitioned, wherein a partition is an aggregation of a number of the drives and a number of the tapes smaller than a total number of drives and a total number tapes, each partition providing a separate Swift-On-Disk File System Application Programming Interface (API) over the second external interface.

12. The system according to claim 1, further comprising a user interface configured to determine one or more of the following parameters: partitioning, cache size, cache-rules, tapes to be copied and export of tapes.

13. The system according to claim 1, wherein the first interface is one of the following: scsi, fc, iscsi and sas, and wherein the second interface is one of the following: RESTful interface and SWIFT Storage Node interface.

14. A method for implementing a Swift Storage Node, comprising:
using a media library comprising one or more drives and one or more tapes formatted according to a Linear Tape File System (LTFS);
using a management system connected over a first interface to the media library and over a second interface to a Swift Proxy Server, comprising a processor, a cache data store and a set of computer instructions executable on the processor;
providing a Swift-On-Disk File System Application Programming Interface (API) over the second external interface;
using a Virtual File System (VFS) base on the cache data store and the tapes formatted according to the LTFS to be mapped to a Swift-On-Disk File standard;
receiving a request over the Swift-On-Disk File System API to store an object according to the Swift-On-Disk standard, storing and registering the object in the VFS, wherein the object is stored in a first step on the cache data store, controlling the media library to move a respective tape into a respective drive, mounting the respective tape using the LTFS in the respective drive according to the VFS, moving the object from the cache data store to the tape using LTFS and updating the VFS; and
receiving a request over the Swift-On-Disk File API to read an object, determining in the VFS the location of the object, and:
providing the object from the cache data store based on a determination that the object is still in the cache data store, else
controlling the library to move a respective tape into a respective drive, mounting the respective tape using the LTFS in the respective drive according to the VFS, loading the object using the LTFS and providing the object by the Swift-On-Disk File System API over the second external interface.

15. The method according to claim 14, wherein the VFS unifies several LTFS on the tapes and the cache data store as one large unified storage area to provide the unified storage area to the Swift-On-Disk File standard.

16. The method according to claim 14, wherein a SWIFT Standard Storage Node structure is kept for tape based storage by help of an adapted virtual file system including a metadatabase.

17. The method according to claim 14, wherein a complete storage node file tree and the object is stored in the VFS.

18. The method according to claim 17, wherein a separate cache area defined on the cache data store is provided which is large enough to store a copy of all folder/file structure on the tapes, and which is copied to the tapes regularly on a base of rules.

19. The method according to claim 14, wherein the VFS consists of a VFS-table storing object identifications together with a location of the object on the tapes or the cache data store.

20. The method according to claim 14, wherein the VFS-table comprises several location entries for one object identification together with a date of change where the object is stored on multiple ones of the tapes or on the cache data store and one of the tapes.

21. The method according to claim 14, wherein the VFS generates tape copies in the background for redundant data storage.

22. The method according to claim 21, wherein tape copies are exported out of the library.

23. The method according to claim 14, wherein the objects in the cache data store are removed based on a copy of a respective object being on the tapes, wherein a cache-rule determines the respective object to be removed.

24. The method according to claim 14, wherein the media library is partitioned by aggregating a number of the drives and a number of the tapes smaller than a total number of the drives and a total number of the tapes to a partition, each partition providing a separate Swift-On-Disk File System Application Programming Interface (API) over the second external interface.

25. The method according to claim 14, further comprising providing a user interface to determine one or more of the following parameters: partitioning, cache size, cache-rules, tapes to be copied, export of tapes.

26. The method according to claim 14, wherein the first interface is one of the following: scsi, fc, iscsi and sas, and wherein the second interface is one of the following: RESTful interface and SWIFT Storage Node interface.

27. A non-transitory, tangible computer readable medium comprising a set of instructions, which, when executed on one or more processors, causes the method according to claim 14 to be implemented.
